(19) United States
(12) Patent Application Publication
(10) Pub. No.: US 2021/0314382 A1
(43) Pub. Date: Oct. 7, 2021

(54) SYSTEM AND METHOD OF PRESENTING RICH MEDIA CONTENT

(71) Applicant: Rockabox Media Ltd, London (GB)

(72) Inventor: James BOOTH, London (GB)

(73) Assignee: Rockabox Media Ltd, London (GB)

(21) Appl. No.: 17/354,042

(22) Filed: Jun. 22, 2021

Related U.S. Application Data
(63) Continuation-in-part of application No. 15/810,375, filed on Nov. 13, 2017, now abandoned.
(60) Provisional application No. 62/420,643, filed on Nov. 11, 2016.

(51) Int. Cl. H04L 29/06; H04L 29/08

(52) U.S. Cl. CPC H04L 65/604; H04L 65/602; H04L 65/1059; H04L 67/146

(57) ABSTRACT

A system for presenting a rich media content. The system includes at least one user display device with a computing hardware configured to execute a software product thereon and a server arrangement with at least an analysis server coupled via a data communication network for communicating the rich media content to the at least one user display device. The executed software product is operable to enable interaction between the at least one user display device and a user of the at least one user display device; communicate with the server arrangement via the data communication network; detect information about hardware and web portal characteristics of the at least one user display device and communicate the information about hardware and web portal characteristics to the analysis server in the server arrangement for determine unique content delivery parameters.

### TECHNICAL FIELD

The present disclosure relates to a system and method for reading and verifying technical capabilities of a web-connected portal for media content delivered over a data communication network. More particularly, the present disclosure relates to an intelligent programmatic content delivery arrangement for modifying internet-based media based on portal technical specifications, media platform and user profiles. Furthermore, the present disclosure relates to software products recorded on machine readable data storage media, wherein the software products are executable on computing hardware for implementing aforesaid methods.

### BACKGROUND

The success of advertising campaigns depends on various factors for example proper planning and profiling. Generally, a company purchases advertising space or time from an advertising company with the intent to provide media content to the targeted audience. Furthermore, the provided media content is designed to be attractive and suitable for viewing conveniently by the targeted section of audience.

Moreover, the purchasing company will only wish to buy advertisement spaces that are technologically supported by the advertising contents. Furthermore, the content should be supported by characteristics for example file format, size, position and so forth. Additionally, it is also important that the advertisement should reach the targeted audience. However, the advertising campaigns may not serve its purpose of attracting the targeted audience due to certain problems for example lack of support for content's format. Additionally, if the content's format is not in the supported format the audience will not be able to view it. Moreover, due to the automated nature of web-based advertising campaigns the purchasing company may end up paying for the non-viewable and unsupported content repeatedly. Furthermore, the purchasing company may wish to pre-emptively choose the advertisement to suit the media content platform based on prior information about the platform.

In Prior attempts for providing media content to targeted audience have focused on localization by geographic area, such as US20040083133 “Method and system for providing network-based target advertising and encapsulation”, where an ad request is coupled with geo-location data for a user, returning a geographically-focused advertisement for the user.

In another prior art filtering rules have been used for placing multiple advertisements adjacent to each other, such as U.S. Pat. No. 8,249,918 “Context based content adjacency filtering”, where a media-providing server contains rules for relationships among media content. Additionally, the media-providing server then filters out such content that is mismatched to content used previously.

Furthermore, various other methods of pre-selecting media content has been described. However, neither of these examples, nor any known technology on the market, evaluates the technical capabilities or individual user characteristics of a web portal so that provided content is fully supported and viewable by a user.

Therefore, in light of the foregoing discussion, there exists a need to overcome the aforementioned drawbacks associated with pre-selecting media content.

### SUMMARY

The present disclosure seeks to provide a system for presenting a rich media content.

The present disclosure also seeks to provide a method for presenting a rich media content.

Moreover, the present disclosure seeks to provide a software product recording on machine-readable data storage media, characterized in that the software product is executable upon computing hardware for implementing a method of presenting a rich media content.

According to a first aspect, there is provided a system for presenting a rich media content, the system including:
(i) at least one user display device comprising a computing hardware configured to execute a software product thereon; and
(ii) a server arrangement comprising at least an analysis server, coupled via a data communication network for communicating the rich media content to the at least one user display device; wherein:
   (a) the executed software product is operable to enable interaction between the at least one user display device and a user of the at least one user display device and to communicate with the server arrangement via the data communication network;
   (b) the software product is operable to detect information about hardware and web portal characteristics of the at least one user display device, wherein the web portal characteristics include at least one of type, configuration, style, identity and/or associated bandwidth of the web portal;
   (c) the software product is operable to communicate the information about hardware and web portal characteristics to the analysis server in the server arrangement; and
   (d) the analysis server is operable to determine unique content delivery parameters based on the information about hardware and web portal characteristics as communicated by the software product.

The present disclosure seeks to provide an improved system for presenting rich media content; furthermore, the system is an intelligent programmatic content delivery arrangement, moreover the system is capable of providing more appropriate delivery of content to the one or more users.

Optionally, the software product is operable to generate a unique visual presentation of the rich media content based on the unique content delivery parameters determined by the analysis server.

Optionally, the system further comprises a database operable to receive connection from the analysis server; the database comprises pre-determined characteristics of the hardware and web portal characteristics of the at least one user display device.

Optionally, the software product is operable to, update or modify the user display device in real-time based on the unique content delivery parameters provided by the analysis server.

Optionally, the software product is operable to modify the user display device by optimizing visual size of the rich media content based on the unique content delivery parameters provided by the analysis server.

Optionally, the software product is operable to collect information associated with the user display device and web portal.

Optionally, the information associated with the user display device includes at least one of, position of the rich media content as displayed in the user display device; type of the rich media content displayed in the user display device; hardware device identity of the user display device; screen size of web portal displayed in the user display device; web portal identity of web portal displayed in the user display device; and data communication speed associated with the data communication network.

Optionally, the software product is operable to maintain a record of the web portal identity that is independent of connection status to the analysis server. More optionally, the record is maintained by means of a cookie.

Optionally, the analysis server is operable to collect information associated with the web portal identity from the software product and directs the database to store data related to the web portal. More optionally, the data stored in the database is a record of specific rich media content to be displayed on the web portal.

According to a second aspect, an embodiment of the present disclosure provides a method for presenting a rich media content, the method including:
(a) executing a software product via a computing hardware of a at least one user display device, wherein the software product enables interaction between the at least one user display device and a user of the at least one user display device;
(b) detecting information about hardware and web portal characteristics of the at least one user display device via the executed software product based upon the interaction between the at least one user display device and the user thereof, wherein the web portal characteristics include at least one of type, configuration, style, identity and/or associated bandwidth of the web portal;
(c) communicating the detected information from the software product to an analysis server in a server arrangement via a data communication network;
(d) using the analysis server to determine unique content delivery parameters based upon the communicated information; and
(e) providing the at least one user display device with the rich media content to be displayed based on the unique content delivery parameters.

Optionally, the software product, is operable to generate a unique visual presentation of the rich media content based on the unique content delivery parameters determined by the analysis server.

Optionally, the method further comprises operating a database to receive connection from the analysis server; the database comprises pre-determined characteristics of the hardware and web portal characteristics of the at least one user display device.

Yet more optionally, the software product is operable to update or modify the user display device in real-time based on the unique content delivery parameters provided by the analysis server.

Optionally, the software product is operable to modify the user display device by optimizing visual size of the rich media content based on the unique content delivery parameters provided by the analysis server.

Optionally, the software product is operable to collect information associated with the user display device and web portal.

Optionally, the information associated with the user display device includes at least one of, position of the rich media content as displayed in the user display device; type of the rich media content displayed in the user display device; hardware device identity of the user display device; screen size of web portal displayed in the user display device; web portal identity of web portal displayed in the user display device; and data communication speed associated with the data communication network.

Optionally, the software product is operable to maintain a record of the web portal identity that is independent of connection status to the analysis server. Optionally, the record is maintained by means of a cookie.

Yet more optionally, the analysis server is operable to collect information associated with the web portal identity from the software product and directs the database to store data related to the web portal.

Optionally, the data stored in the database is a record of specific rich media content to be displayed on the web portal.

It will be appreciated that features of the present disclosure are susceptible to being combined in various combinations without departing from the scope of the present disclosure as defined by the appended claims.

### DESCRIPTION OF THE DIAGRAM

Embodiments of the present disclosure will now be described, by way of example only, with reference to the following diagrams wherein:

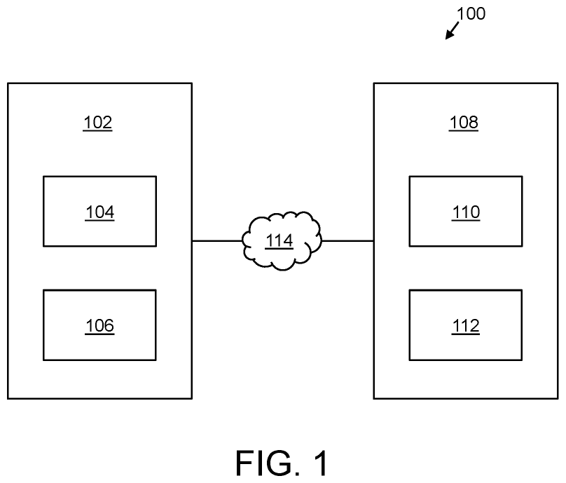

FIG. 1 is a block diagram of a system for presenting rich media content, in accordance with different embodiments of the present disclosure;

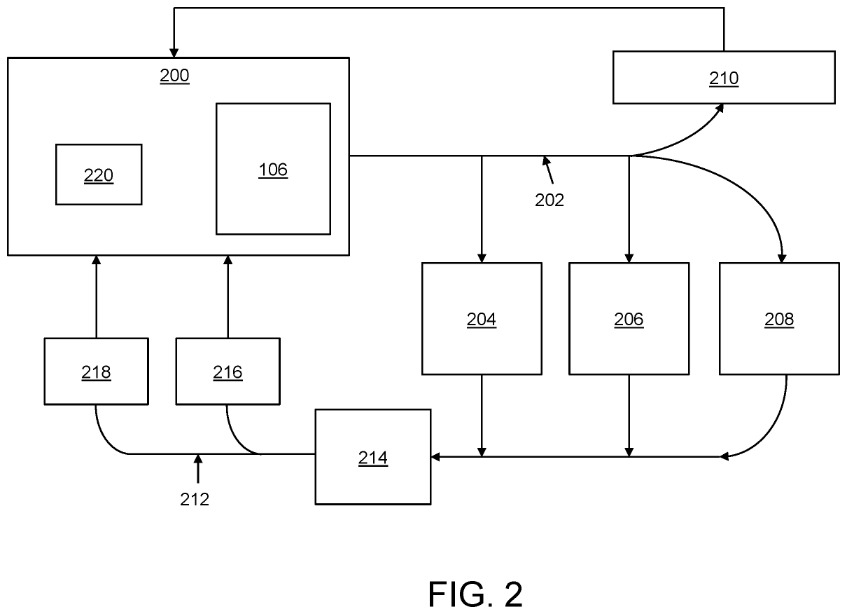

FIG. 2 is a schematic illustration of an exemplary implementation of the system of FIG. 1, in accordance with different embodiments of the present disclosure; and

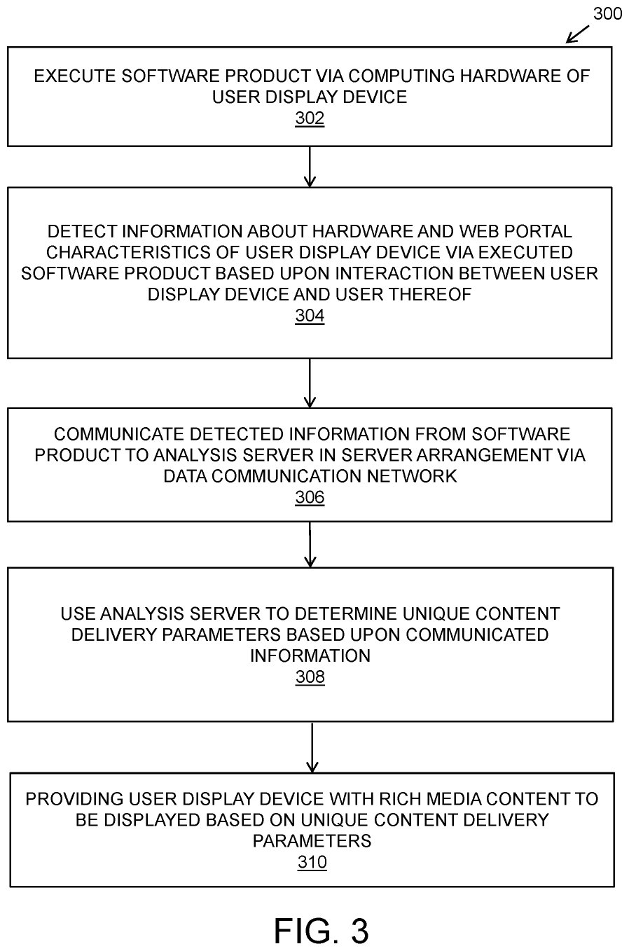

FIG. 3 is an illustration of steps of a method of presenting rich media content, accordance with different embodiments of the present disclosure.

### DESCRIPTION OF EMBODIMENTS

In overview, embodiments of the present disclosure are concerned with system for presenting a rich media content. Moreover, embodiments of the present disclosure are concerned with methods of presenting a rich media content.

Referring to FIG. 1, there is shown a block diagram of a system 100 for presenting a rich media content, in accordance with different embodiments of the present disclosure. The system 100 includes at least one user display device 102 comprising a computing hardware 104 configured to execute a software product 106 thereon. As shown, the system 100 includes a server arrangement 108 comprising at least an analysis server 110 coupled via a data communication network 114 for communicating the rich media content to the at least one user display device 102. Furthermore, the server arrangement 108 includes a database 112 for storing data.

The system 100 relates an arrangement for optimizing the rich media content to be displayed on a web portal of the user display device 102. Optionally, the system 100 is operable to optimize the rich media content to deliver optimal visual experience for a targeted user. Optionally, the system 100 is operable to provide a real-time assessment of the characteristics of a web portal used in the user display device 102. Subsequently, the system 100 is operable to provide the targeted rich media content. Additionally, the targeted rich media content is optimized for providing optimal visual experience in the web portal of the user display device 102. For example, the targeted rich media content may be a visually expanding or larger piece of content with respect to the web portal and default content size.

Throughout the present disclosure, the term “rich media content” relates to digital media that exhibits dynamic or interactive properties. Optionally, the rich media content comprises a multimedia document that may include, for example, text, graphics, audio and video. Furthermore, the rich media content can include hyperlinks, which, when selected, bring up, for example, a new multimedia document or start a video player. Furthermore, the rich media content includes media players made up of player components which each have a dependence on class loads. Optionally, the rich media content refers to a document containing one or more rich media files and one or more rich media players and may also include multiple types of rich media files and players.

The system 100 includes the at least one user display device 102. Throughout the present disclosure, the term “user display device” relates to an electronic device associated with (or used by) a user that is capable of enabling the user to perform specific tasks associated with the aforementioned system. Furthermore, the user display device 102 is intended to be broadly interpreted to include any electronic device that may be used for voice and/or data communication over a wireless communication network. Examples of the user display device 102 includes, but are not limited to, cellular phones, personal digital assistants (PDAs), handheld devices, wireless modems, laptop computers, personal computers, and so forth. Moreover, the user display device 102 may alternatively be referred to as a mobile station, a mobile terminal, a subscriber station, a remote station, a user terminal, a terminal, a subscriber unit, an access terminal, etc. Additionally, the user display device 102 includes a casing, a memory, a processor, a network interface card, a microphone, a speaker, a keypad, and a display. Moreover, the user display device 102 is to be construed broadly, so as to encompass a variety of different types of mobile stations, subscriber stations or, more generally, communication devices, including examples such as a combination of a data card inserted in a laptop. Such communication devices are also intended to encompass devices commonly referred to as “access terminals”.

The user display device 102 comprises the computing hardware 104. Throughout the present disclosure, the term “computing hardware” relates to a computational element that is operable to and processes instructions that drive the user display device 102. Optionally, the computing hardware 104 includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the computing hardware 104 can be implemented as one or more individual processors, processing devices and various elements associated with a processing device that may be shared by other processing devices. Additionally, the computing hardware 104 can be arranged in various architectures for responding to and processing the instructions that drive the user display device 102.

The computing hardware 104 is configured to execute the software product 106. Throughout the present disclosure, the term “software product” relates to a user agent application that includes instructions stored in storage medium such as RAM, a hard disk, optical disk, or so forth, and is also intended to encompass so called “firmware” that is software stored on a ROM or so forth. Optionally, the software product 106 can be organized in various ways, and may include software components organized as libraries, internet-based programs stored on a remote server, source code, interpretive code, object code, directly executable code, and so forth. Furthermore, the software product 106 can be implemented as system level code or calls to other software residing on a server or other location to perform certain functions. Optionally, the software application includes various modules for storing and processing information related to the user display device 102.

The software product 106 is operable to detect information about a hardware and web portal characteristics of the at least one user display device 102. Optionally, the hardware characteristics of the at least one user display device 102 includes the features related to a display device used by the user. For example, the hardware characteristics may include, the dimensions of the display unit of the user display device 102, the dimension of the area of the display unit wherein the user display device 102 is configured to display a web portal, the type of the web portal used by the user display device 102 to display the rich media content, the data communication configuration of the user display device 102, and the likes. Throughout the present disclosure, the term “web portal” relates to a collection of related websites pages, images, videos or other digital assets which are addressed relative to a common Uniform Resource Locator (URL), often consisting of only a domain name or an IP address and a root path in an Internet Protocol-based network. Optionally, the terms “web portal”, “web site”, and “Publisher Page” may be used interchangeably and refers to any internet-connected web page or application interface capable of sending and receiving instructions. The web portal is hosted on at least one server that is accessible by the user display device 102 via a network such as the Internet or a private local area network. Optionally, the URL of the web portal may be read via a number of alternative detection methods, such as, by a data passed through a bid process, by a data fed via a delivery environment on the web portal itself, and by a direct interrogation of the delivery environment and a browser data by the software product 106 controlling delivery and display of the rich media content. Optionally, the URL of the web portal may be passed back to the analysis server 110 and broken up into its constituent parts such as, a top-level domain, a subdomain, and a path within the domain. The constituent parts of the URL may be compared with values stored within the database 112 to gather any special requirements of the constituent parts of the URL that are set at any level, for example, from overall domain down to individual page level, encompassing subdomains and channels within the web portal, as determined by their own URL structure policy. Optionally, the web portal characteristics of the at least one user display device 102 includes the features related to a web portal displayed by the user display device 102. For example, the web portal characteristics may include the style properties of the web portal. In such instance the style property is a CSS property or class affecting the presentation of elements in the web portal. In such instance, the elements may the contents displayed in the web portal, such as, texts, images, videos, players, and the like. Optionally, the web portal may be scanned for individual CSS identifiers which match to the individual CSS identifiers stored in the database 112, and the software product 106 may configure the rich media content to suit the page settings, based on the individual CSS identifiers stored in the database 112.

Optionally, the software product 106 is operable to collect information associated with the user display device 102 and web portal. Optionally, the information collected by the software product 106 relates to the hardware and web portal characteristics of the user display device 102. Optionally, the information associated with the user display device 102 includes at least one of position of the rich media content as displayed in the user display device 102, type of the rich media content displayed in the user display device 102, a hardware device identity of the user display device 102, screen size of web portal displayed in the user display device 102, web portal identity of web portal displayed in the user display device 102, and data communication speed associated with the data communication network of the user display device 102. In an example, the position of the rich media content “A” as displayed in the user display device 102 may be a top right-side corner of a website “Z”. In another example, the rich media content “A” displayed at the top right-side corner of the website “Z” may be video content. In another example, the hardware device identity of the user display device 102 displaying the video content as the rich media content “A” displayed at the top right-side corner of the website “Z” may be the media access control (MAC) address of the user display device 102. In another example, the screen size of website displayed in the user display device 102 may be 960px wide. In another example, the website displayed in the user display device 102 may include a web portal identity “WXY” that may be verified by the certificate authority. In another example, the user display device 102 may be configured to perform data communication at a speed of 100 Mbps. In such instance, the software product 106 may be operable to collect the aforesaid information and store the information temporally in a memory of the user display device 102. Optionally, the information associated with the web portal may include, name and information about the web portal, the software platform or framework on which the web portal is built, the browser that the web portal is displayed in. Beneficially, the software product 106 is operable to collect a broad range of information about the web portal characteristics, limited only by the technology environment of operation. Moreover, the software product 106 is operable to detect any available parameters from the delivery environment such as, existence of particular functional plug-in installed on the web browser, orientation of the user display device 102, position of the rich media content relative to currently-visible section of content based on the user's scroll position on the screen of the user display device 102, and so on.

Optionally, the software product 106 is operable to scrutinize the websites and surveys of the media landscape to match an advertising campaign with an advertising slot on the website. Furthermore, the software product 106 is operable to use the hardware and web portal characteristics of the at least one user display device 102 to identify the corresponding rich media content to be delivered on the website.

Optionally, the software product 106 is operable to maintain a record of the web portal identity that is independent of connection status to the analysis server 110 (explained in details herein later). Optionally, the software product 106 is operable to use the web portal identity to identify the categories of the web portal. Optionally, the categories of the web portal are rich media displayable websites and rich media non-displayable websites. Furthermore, the rich media displayable websites refer to the websites that operable to display the rich media content and the rich media non-displayable websites refer to the website that are not capable to displaying the rich media content. Optionally, the web portal identities associated with the rich media non-displayable websites are used to generate a blacklist. Furthermore, the record is operable to store the blacklist and the list of the websites that are capable of displaying the rich media content. Optionally, the record is maintained by means of a cookie. Furthermore, the term “cookie” as used herein is meant to include a file or other data structure stored on a storage system that is used by a browser-based application such as a web browser of the user display device 102.

Optionally, the software product 106 is configured to determine any number of dynamic properties of the web portal environment which affects at least one of: delivery, rendering, display, animation and interaction parameters of the rich media content. Such properties may include the internal dimensions of the web page element in which a code of the software product 106 is delivered, and the dimensions of the web browser window of the user display device 102 on which the web portal is displayed within. Beneficially, this helps software product 106 to determine factors such as scroll rate for particular proprietary rich media formats delivered to the user display device 102. Moreover, this ensure that whole intended rich media content is properly displayed on the user display device 102 without the risk of any part of the rich media content being hidden through misconfiguration or user action.

Optionally, the software product 106 is configured to perform a self-learning process from the information stored in the record. Optionally, the software product 106 is operable to use the information generated by the self-learning process to dynamically determine websites that are operable to display and/or not display the rich media. Subsequently, allowing faster connection speed for loading the websites onto the browser-based application of the user display device 102.

The executed software product 106 is operable to enable interaction between the at least one user display device 102 and a user of the at least one user display device 102 and to communicate with the server arrangement via the data communication network. Optionally, the software product 106 is operable to generate a user interface to be displayed on the user display device 102 to facilitate interaction between the at least one user display device 102 and a user of the at least one user display device 102. Throughout the present disclosure, the term ‘user’ as used herein relates to any entity including a person (i.e., human being) or a virtual personal assistant (an autonomous program or a bot) operating the user display device 102 and/or system 100 described herein. Furthermore, throughout the present disclosure, the term ‘user interface (UI)’ relates to a structured set of user interface elements rendered on a display screen of the user display device 102. Optionally, the user interface (UI) rendered on the display screen is generated by any collection or set of instructions executable by the software product 106. Additionally, the user interface (UI) is operable to interact with the user to convey graphical and/or textual information and receive input from the user. Specifically, the user interface (UI) used herein is a graphical user interface (GUI). Furthermore, the user interface (UI) elements refer to visual objects that have a size and position in user interface (UI). The user interface element may be visible, though there may be times when a user interface element is hidden. A user interface control is considered to be the user interface element. Text blocks, labels, text boxes, list boxes, lines, and images windows, dialog boxes, frames, panels, menus, buttons, icons, etc. are examples of the user interface elements. In addition to size and position, the user interface elements may have other properties, such as a margin, spacing, or the like.

Furthermore, the software product 106 is operable to facilitate communication between the user display device 102 and the server arrangement 108 via the data communication network 114. Throughout the present disclosure, the term ‘server arrangement’ relates to a structure and/or module that include programmable and/or non-programmable components configured to store, process and/or share information. Optionally, the server arrangement 108 includes any arrangement of physical or virtual computational entities capable of enhancing information to perform various computational tasks. Furthermore, it should be appreciated that the server arrangement 108 may be both single hardware server and/or plurality of hardware servers operating in a parallel or distributed architecture. In an example, the server may include components such as memory, a processor, a network adapter and the like, to store, process and/or share information with other computing components, such as user device/user equipment. Optionally, the server arrangement 108 is implemented as a computer program that provides various services (such as database service) to other devices, modules or apparatus. Furthermore, throughout the present disclosure, the term “data communication network” relates to an arrangement of interconnected programmable and/or non-programmable components that are configured to facilitate data communication between one or more electronic devices and/or databases, whether available or known at the time of filing or as later developed. Furthermore, the data communication network 114 may include, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the data communication network 114 includes wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. Optionally, in the event wherein the server arrangement 108 include one or more elements (such as databases) and/or hardware servers (such as a server for analysis of data), the elements may be interconnected using the data communication network 114.

The server arrangement 108 comprising at least an analysis server 110 (such as Rockabox Publisher Services) coupled via the data communication network 114 for communicating the rich media content to the at least one user display device 102. Optionally, the analysis server 110 is operable to perform the analysis of the data provided by the user display device 102. Throughout the present disclosure, the term ‘analysis server’ as used herein relates to programmable and/or non-programmable components configured to execute one or more software application for storing, processing and/or share data and/or set of instruction. Optionally, the analysis server 110 can include, for example, a component included within an electronic communications network. Additionally, the analysis server 110 includes one or more data processing facilities for storing, processing and/or share data and/or set of instruction. Furthermore, the analysis server 110 includes hardware, software, firmware or a combination of these, suitable for storing and processing various information and services accessed by the one or more user using the one or more user equipment. Optionally, the analysis server 110 include functional components, for example, a processor, a memory, a network adapter and so forth.

The software product 106 is operable to communicate the information about hardware and web portal characteristics to the analysis server 110 in the server arrangement 108. Optionally, the software product 106 communicates the information about the hardware and web portal characteristics via the data communication network 114. Optionally, the analysis server 110 is operable to process the information related to the hardware and web portal characteristics provided by the software product 106. Beneficially, the communication between the software product 106 and the analysis server 110 is a two-way read/write operation that determines the correct configuration of the rich media content and reports back any anomalies if found. Advantageously, this makes the system 100 a dynamic, self-regulating collection of complementary parts.

Optionally, the system 100 further comprises a database 112 operable to receive connection from the analysis server 110. Optionally, the server arrangement 108 includes the database 112. Furthermore, the database 112 is communicably coupled with the analysis server 110. Throughout the invention, the term ‘database’ as used herein relates to an organized body of digital information regardless of the manner in which the data or the organized body thereof is represented. Optionally, the database 112 may be hardware, software, firmware and/or any combination thereof. For example, the organized body of related data may be in the form of a table, a map, a grid, a packet, a datagram, a file, a document, a list or in any other form. The database 112 includes any data storage software and systems, for example, a relational database like IBM DB2 and Oracle 9. Optionally, the database 112 may be used interchangeably herein as database management system, as is common in the art. Furthermore, the database 112 management system refers to the software program for creating and managing one or more databases. Optionally, the database 112 may be operable to support relational operations, regardless of whether it enforces strict adherence to the relational model, as understood by those of ordinary skill in the art. Additionally, the database 112 is populated by data elements. Furthermore, the data elements may include data records, bits of data, cells, that can be used interchangeably herein and all intended to mean information stored in cells of a database 112. The database 112 comprises pre-determined characteristics of the hardware and web portal characteristics of the at least one user display device 102. Optionally, the database 112 is operable to store the information about the hardware and web portal characteristics provided by the software product 106 as pre-determined characteristics of the hardware and web portal characteristics.

Optionally, the analysis server 110 is operable to collect information associated with the web portal identity from the software product 106 and direct the database 112 to store data related to the web portal. In an example, the web portal identity “M” of a website “V” may be configured identify that the webpage “V” is capable of displaying the rich media content. In such instance the database 112 is operable to store the web portal identity “M” that describes that the website is capable of displaying rich media content. In such instance the analysis server 110 is operable to access the web portal identity “M”. In such instance, the analysis server 110 is operable to implement the web portal identity “M” modifies the rich media content to best suit the website “V”. In another example, the web portal identity “D” of a website “L” may be configured identify that the webpage “L” is not capable of displaying the rich media content. In such instance the database 112 is operable to store the web portal identity “D” that describes that the website is not capable of displaying the rich media content. In such instance the analysis server 110 is operable to access the web portal identity “D”. In such instance, the analysis server 110 may be configured to display an alternative content such as text.

Optionally, the data stored in the database 112 is a record of the specific rich media content to be displayed on the web portal. In an example, a website “V” having a web portal identity “D” may be capable of displaying rich media content “H”. In such instance, a website “V” may not be capable of displaying rich media content “K”. In such instance the database 112 is operable to record that the website “V” having a web portal identity “D” is capable of displaying the rich media content “H” and is not capable of displaying the rich media content “K”. In such instance, the analysis server 110 is operable to access the web portal identity “D” is operable to display the rich media content “H” in the website “V” and generate an alternative content, such as text that describes the rich media content “K”, to replace the rich media content “K”.

The analysis server 110 is operable to determine unique content delivery parameters based on the information about the hardware and web portal characteristics as communicated by the software product 106. Optionally, the unique content delivery parameters relates to attributes of the rich media content. Optionally, the analysis server 110 is operable to determine the unique content delivery parameters for individual web portal used in the user display device 102. In an example, website “V” may be displayed in the user display device 102 having web portal identity “D” and a screen size of 960px width. In such instance, the user display device 102 displaying the website “V” may include data communication at a speed of 100 Mbps. In such instance, a rich media content “H” and a textual content “J” may be displayed in the website “V”. In such instance, an area “P” in the screen size of 960px width may be occupied by the textual content “J” and an area “Q” in the screen size of 960px width may be occupied by the rich media content “H”. In such instance, unique content delivery parameter determined by the analysis server 110 may describe that area “Q” displaying the rich media content “H” is greater than the area “P” displaying the textual content “J” for user convenience of viewing contents in the website “V”.

The software product 106 is operable to generate a unique visual presentation of the rich media content based on the unique content delivery parameters determined by the analysis server 110. Optionally, the unique visual presentation relates to a mode of displaying the rich media content in a website displayed in the user display device 102. For example, the unique content delivery parameters determined by the analysis server 110 for displaying the plurality of rich media content “S”, “N” and “U”, on a website “ABC”. In such instance, the unique content delivery parameters may describe that the rich media content “S” will be displayed in an area within the website “ABC” that is greater than the areas where the rich media contents “N” and “U”, would be displayed within the website “ABC”. In such instance, the unique content delivery parameters may describe that the areas where the rich media contents “N” and “U”, would be displayed within the website “ABC” are equivalent to each other. In such instance, the unique visual presentation generated by the software product 106 would display the rich media content “S”, “N” and “U” in the website “ABC” accessed by the user in the user display device 102 in a manner wherein the rich media content “S” is displayed in an area greater than the areas where the rich media contents “N” and “U”, and the areas where the rich media contents “N” and “U” are equivalent to each other.

Optionally, the software product 106 is operable to update or modify the user display device 102 in real-time based on the unique content delivery parameters provided by the analysis server 110. Optionally, the software product 106 may be operable to initiate the installation of a new software and/or a software update that may be used to display the rich media content. Optionally, the unique content delivery parameters provided by the analysis server 110 may include a set of instructions to update or modify the user display device 102 in real-time. In an example, the set of instructions to update or modify the user display device 102 in real-time may include installation of a media player plugin and/or update a preinstalled media player plugin for playing a rich media content such as a video.

The software product 106 is operable to modify the user display device 102 by optimizing visual size of the rich media content based on the unique content delivery parameters provided by the analysis server 110. In an example, the software product 106 optimizing visual size of the rich media content to expand its size for a better display of the content. In such instance, the software product 106 is operable to modify the brightness of the screen of the user display device 102, such as increase the brightness of the screen.

Optionally, the software product 106 is operable to provide the analysis server 110 with the information that describes the content with which the user using a web-browser interacts. Optionally, the analysis server 110 may be operable to use the aforesaid information to generate the unique content delivery parameters. Furthermore, the analysis server 110 may be operable to use the aforesaid information for identifying the user behaviour and subsequently, modifying the rich media content to be of high relevance and of contextually appropriate for the user. Optionally, the analysis server 110 may be operable to use meta-tags to mark website with unique content delivery parameters.

Optionally, the system 100 is operable to provide the identified the user behaviour to a third party such as a campaign manager for purposes of campaign planning. Optionally, the system 100 is operable to operate as a diagnostic tool to analyse and estimate campaign's success. Beneficially, the system 100 may be dynamically configurable by the third party such as the campaign manager and centrally managed by owner of the system 100. Moreover, the owner of the system 100 would be an administrator of the system 100 and may override the configurations done by the third party. Optionally, the system 100 is a dynamic automated media technology that can be employed by users producing and disseminating media as, for example, is done in advertising, public relations and/or brand promotion activities.

Optionally, every aspect of the monitoring and configuration settings regarding the delivery of the rich media content, as read by the software product 106 and dynamically recorded by the database 112 is fed back to the analysis server 110. Optionally, the analysis server 110 reports a state of health of delivery of the rich media content being delivered to web portal to an authorised user such as the third party, based on the received feedback. More optionally, the analysis server 110 is operable to build custom reports for ad hoc analysis by the third party. Beneficially, the system 100, may report issues to the third party which hinders successful delivery of the rich media content to the user display device 102.

It will be appreciated that there are numerous variables involved in the delivery of the rich media content through the web portal. In such implementation, the numerous variables include (but not limited to) the user display device type, operating system installed on the user display device, computing load on the computing hardware of the user display device, screen type of the user display device, scree resolution of the user display device, screen dimensions of the user display device, data communication network bandwidth available, plugins installed on the user display device and so on, communicated through the page markup and other delivered code which goes into the rendered web portal, with much in between. Moreover, it is hugely complex to ensure the successful delivery and rendering of rich media content into any web portal on any user device via any channel, wherein there may be many layers of control and data injection typical with a normal rich media delivery. Generally, this often requires 2-3 weeks of testing and feedback via email and phone calls from the user and any changes made by web portal staff can undo all previous configurations and require a full round of testing to begin again. Advantageously, the present system 100 removes all of this need, by providing detailed and automated control of delivery and rendering, and by providing continuous and ongoing feedback to the system 100 which acts as a central platform. Beneficially, the analysis and feedback happen in real-time, and configuration decisions and data feedback happen in milliseconds rather than days or weeks.

Referring to FIG. 2, there is shown a schematic illustration of an exemplary implementation of the system 100 of FIG. 1, in accordance with different embodiments of the present disclosure. As shown, the web portal, 200 is loaded by a user on a device 102. The software product 106 detects characteristics of the environment by tag or real-time analysis of the web portal environment and platform. Furthermore, the software product 106 is operable to communicate the characteristics via the data communication network 114. Furthermore, the communication with the analysis server 110 (such as Rockabox Publisher Services), in one instance, performs a determination 202 of whether to deliver a rich expanded media content 204, and non-expanded media content 206, and/or to put the specific site on a white or blacklist 208. Additionally, after a determination of the media content type in 210, a third-party bidder or intelligent system provider initiates media choice in a Supply Side Platform 212, comprising an initiation of the media auction in which the system provider (RBX) and third-party bidders 214 use the real-time bidding system (RTB), 216 and the private market places (PMP), 218 delivers the content 220 which is shown on the portal 200.

Referring to FIG. 3, there are shown steps of a method 300 of presenting rich media content, accordance with different embodiments of the present disclosure, in accordance with an embodiment of the present disclosure. At a step 302, a software product of at least one user display device is executed via computing hardware. At a step 304, information about hardware and web portal characteristics of the at least one user display device via the executed software product based upon the interaction between the at least one user display device and the user thereof is detected. At a step 306, the detected information from the software product to the analysis server in the server arrangement is communicated via a data communication network. At a step 308, the analysis server is used to determine unique content delivery parameters based upon the communicated information. At a step 310, the at least one user display device is provided with the rich media content to be displayed based on the unique content delivery parameters.

The steps 302 to 310 are only illustrative and other alternatives can also be provided where one or more steps are added, one or more steps are removed, or one or more steps are provided in a different sequence without departing from the scope of the claims herein. In an example, the method comprises the software product, wherein the software product is operable to generate a unique visual presentation of the rich media content based on the unique content delivery parameters determined by the analysis server. In another example, the method further comprises operating a database to receive connection from the analysis server wherein the database comprises pre-determined characteristics of the hardware and web portal characteristics of the at least one user display device. In yet another example, the method further comprises the software product operable to update or modify the user display device in real-time based on the unique content delivery parameters provided by the analysis server.

In one example, the method further comprises the software product operable to modify the user display device by optimizing visual size of the rich media content based on the unique content delivery parameters provided by the analysis server. In another example, the method further comprises the software product operable to collect information associated with the user display device and web portal. In yet another example, the method further comprises the information associated with the user display device includes at least one of position of the rich media content as displayed in the user display device; type of the rich media content displayed in the user display device; hardware device identity of the user display device; screen size of web portal displayed in the user display device; web portal identity of web portal displayed in the user display device; and data communication speed associated with the data communication network.

In one example, the method further comprises the software product operable to maintain a record of the web portal identity that is independent of connection status to the analysis server. In another example, the record is maintained by means of a cookie. In yet another example, the method further comprises the analysis server operable to collect information associated with the web portal identity from the software product and directs the database to store data related to the web portal. In another example, the data stored in the database is a record of specific rich media content to be displayed on the web portal.

The system for presenting a rich media content of the present disclosure provides an arrangement with improved efficiency for providing optimized rich media content to be displayed on the user display device. Optionally, the system for presenting a rich media content is operable to adjust the display of the contents in a website accessed by the user for providing a improved view of the contents in the website. Optionally, the system is operable to determine the websites that are not able to display rich media content. Furthermore, the system is operable to generate alternative content to replace the rich media content for the website that is not operable to display rich media content.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A system for presenting a rich media content, the system including:
(i) at least a one user display device comprising a computing hardware configured to execute a software product thereon; and
(ii) a server arrangement comprising at least an analysis server coupled via a data communication network for communicating the rich media content to the at least one user display device;
wherein:
(a) the executed software product is operable to enable interaction between the at least one user display device and a user of the at least one user display device and to communicate with the server arrangement via the data communication network;
(b) the software product is operable to detect information about hardware and web portal characteristics of the at least one user display device, wherein the web portal characteristics include at least one of type, configuration, style, identity and/or associated bandwidth of the web portal;
(c) the software product is operable to communicate the information about hardware and web portal characteristics to the analysis server in the server arrangement; and
(d) the analysis server is operable to determine unique content delivery parameters based on the information about hardware and web portal characteristics as communicated by the software product.

2. A system as claimed in claim 1, wherein the software product is operable to generate a unique visual presentation of the rich media content based on the unique content delivery parameters determined by the analysis server.

3. A system as claimed in claim 1, wherein the system further comprises a database operable to receive connection from the analysis server; the database comprises pre-determined characteristics of the hardware and web portal characteristics of the at least one user display device.

4. A system as claimed in claim 1, wherein the software product is operable to update or modify the user display device in real-time based on the unique content delivery parameters provided by the analysis server.

5. A system as claimed in claim 1, wherein the software product is operable to modify the user display device by optimizing visual size of the rich media content based on the unique content delivery parameters provided by the analysis server.

6. A system as claimed in claim 1, wherein the software product is operable to collect information associated with the user display device and web portal.

7. A system as claimed in claim 6, wherein the information associated with the user display device includes at least one of:
position of the rich media content as displayed in the user display device;
type of the rich media content displayed in the user display device;
hardware device identity of the user display device;
screen size of web portal displayed in the user display device;
web portal identity of web portal displayed in the user display device; and
data communication speed associated with the data communication network.

8. A system as claimed in claim 1, wherein the software product is operable to maintain a record of the web portal identity that is independent of connection status to the analysis server.

9. A system as claimed in claim 8, wherein the record is maintained by means of a cookie.

10. A system as claimed in claim 8, wherein the analysis server is operable to collect information associated with the web portal identity from the software product and direct the database to store data related to the web portal, and wherein the data stored in the database is a record of specific rich media content to be displayed on the web portal.

11. A method for presenting a rich media content, the method including:
(a) executing a software product via a computing hardware of a at least one user display device, wherein the software product enables interaction between the at least one user display device and a user of the at least one user display device;
(b) detecting information about hardware and web portal characteristics of the at least one user display device via the executed software product based upon the interaction between the at least one user display device and the user thereof, wherein the web portal characteristics include at least one of type, configuration, style, identity and/or associated bandwidth of the web portal;
(c) communicating the detected information from the software product to an analysis server in a server arrangement via a data communication network;
(d) using the analysis server to determine unique content delivery parameters based upon the communicated information; and
(e) providing the at least one user display device with the rich media content to be displayed based on the unique content delivery parameters.

12. A method as claimed in claim 11, wherein the software product, is operable to generate a unique visual presentation of the rich media content based on the unique content delivery parameters determined by the analysis server.

13. A method as claimed in claim 11, wherein the method further comprises operating a database to receive connection from the analysis server; the database comprises pre-determined characteristics of the hardware and web portal characteristics of the at least one user display device.

14. A method as claimed in claim 11, wherein the software product is operable to update or modify the user display device in real-time based on the unique content delivery parameters provided by the analysis server.

15. A method as claimed in claim 11, wherein the software product is operable to modify the user display device by optimizing visual size of the rich media content based on the unique content delivery parameters provided by the analysis server.

16. A method as claimed in claim 11, wherein the software product is operable to collect information associated with the user display device and web portal.

17. A method as claimed in claim 16, wherein the information associated with the user display device includes at least one of:
position of the rich media content as displayed in the user display device;
type of the rich media content displayed in the user display device;
hardware device identity of the user display device;
screen size of web portal displayed in the user display device;
web portal identity of web portal displayed in the user display device; and
data communication speed associated with the data communication network.

18. A method as claimed in claim 11, wherein the software product is operable to maintain a record of the web portal identity that is independent of connection status to the analysis server.

19. A method as claimed in claim 18, wherein the record is maintained by means of a cookie.

20. A method as claimed in claim 18, wherein the analysis server is operable to collect information associated with the web portal identity from the software product and directs the database to store data related to the web portal, and wherein the data stored in the database is a record of specific rich media content to be displayed on the web portal.
